(19) United States
(12) Patent Application Publication
(10) Pub. No.: US 2009/0036167 A1
(43) Pub. Date: Feb. 5, 2009

(54) System and method for base station heat dissipation using chimneys

(75) Inventor: Anders Sterner, Taby (SE)

Correspondence Address: PERKINS COLE LLP, P.O. BOX 1208, SEATTLE, WA, 98111-1208, US

(73) Assignee: Sanmina-SCI Corporation, San Jose, CA (US)

(21) Appl. No.: 11/720,432

(22) PCT Filed: Nov. 29, 2005
(86) PCT No.: PCT/US05/43253

§ 371 Date: Jun. 19, 2008

Related U.S. Application Data
(60) Provisional application No. 60/631,909, filed on Nov. 29, 2004.

(51) Int. Cl. H04B 1/38

(52) U.S. Cl. 455/561

(57) ABSTRACT

A base station system and method for base station heat dissipation using chimneys where the base station system comprises a first structure, an enclosure, and a chimney. The first structure supports base station circuitry that generates heat. The enclosure encloses the first structure and the base station circuitry and forms an internal space. The chimney comprises a second structure forming dedicated space for heat dissipation. The chimney transfers the heat generated by the base station circuitry from the internal space to an external space outside the enclosure.

### BACKGROUND

1. Field of the Invention

The present invention relates generally to telecommunication base stations and more particularly to a system and method for base station heat dissipation using chimneys.

2. Description of the Prior Art

A base station is a fixed station used for communicating with mobile devices, most commonly mobile phones. The base station, also known as a Base Transceiver Station (BTS), also enables the mobile devices to communicate with a land-based transmission network. Base station size typically ranges from larger macro base stations to smaller micro and pico base stations. The base station may be placed on high buildings, towers, poles, or other structures with a good elevation above a geographic area to be covered. The base station usually consists of a cabinet case or enclosure (i.e. in the case of some micro or pico base stations) or a small building containing electronic equipment (i.e. in the case of some macro base stations). Associated antennas of the base station may be mounted on a dedicated tower, or on an existing building. The base station handles transmission and reception of wireless traffic for a geographic area, and several base stations within the geographic area form a wireless network.

The base station communicates with mobile devices using wireless protocols, such as Code-Division Multiple Access (CDMA) and Groupe Speciale Mobile (GSM) also know as Global System for Mobile Communications. The base station provides call setup among mobile devices and between mobile devices and traditional wired telephones. Call switching and routing may be provided by the base station or by a network operation center that manages and monitors the base station. Along with voice services, data services such as Short Message Service (SMS), e-mail, and Internet browsing may be provided by the base station to the mobile devices.

The base station generally includes base station circuitry configured to provide these wireless telecommunication services. Consequently, the base station circuitry generates heat from providing these services. For example, a radio transceiver in the base station generates heat from the transmission and reception of the wireless traffic. A power supply in the base station generates heat by converting power distributed to the base station to a current usable by the base station circuitry. Increasing the base station's capacity to service a larger number of mobile devices or provide complex voice and data services requires additional base station circuitry or more complex base station circuitry, which may result in greater heat generation. One problem is that the base station renders poor performance if not adequately cooled. When exposed to enough heat, the base station circuitry may suffer damage by melting or catching fire.

To avoid heat damage, the base station circuitry may include fans and/or heat sinks to dissipate the heat. Fans dissipate heat by forcing air over circuitry that generates heat. Fans require a power source to operate and may need additional circuitry to monitor their operation. Heat sinks provide a larger surface area for heat dissipation and typically attach directly to the circuitry that generates heat. The fans and/or heat sinks may add to the cost, size, weight, and complexity of the base station.

The need for fans and/or heat sinks to adequate cool the base station circuitry limits construction of smaller base stations that may provide the same voice and data services as larger macro base stations. The fans and/or heat sinks, when attached to the base station circuitry, may physically limit the proximity one piece of circuitry is installed with another piece of circuitry in the smaller base stations.

### SUMMARY OF THE INVENTION

The invention addresses the above problems by providing a base station system and method for base station heat dissipation using chimneys. The base station system comprises a first structure, an enclosure, and a chimney. The first structure supports base station circuitry that generates heat. The enclosure encloses the first structure and the base station circuitry and forms an internal space. The chimney comprises a second structure forming dedicated space for heat dissipation. The chimney transfers the heat generated by the base station circuitry from the internal space to an external space outside the enclosure.

The base station system may be a macro base station. In other embodiments, the base station system is a micro or Pico base station system. The base station system may provide voice and data services over a protocol, such as GSM or CDMA.

In some embodiments, the chimney is vertical to the enclosure. In other embodiments, the shape of the chimney is a rectangular box. The chimney may also be smaller than the base station system.

The base station system may include a fan that forces the heat from the internal space using an internal airflow that flows over the base station circuitry and into the chimney. The base station system may include a heat sink coupled to the base station circuitry to dissipate the heat into the internal space. The chimney may mount to the base station circuitry maximizing transfer of the heat to the chimney.

In some embodiments, the chimney dissipates the heat from the internal space to the external space using natural convection. The chimney may dissipate heat by a fan that forces air from the second structure to the external space outside the enclosure. In some embodiments, the heat sink mounts to the chimney and dissipates the heat from the chimney to the external space.

The base station system and method advantageously prevent heat damage to the base station circuitry by using the chimney to transfer the heat generated by the base station circuitry to the external space outside the enclosure. The chimney directs the heat generated by the base station circuitry for dissipation away from the base station circuitry.

### BRIEF DESCRIPTION OF THE DRAWINGS

FIG. 1 illustrates a base station system including a chimney providing dedicated space for heat dissipation, in an exemplary implementation of the invention;

FIG. 2 illustrates an internal view of a base station system dissipating heat by forcing air into a chimney, in an exemplary implementation of the invention;

FIG. 3 illustrates a base station system including a chimney mounted to base station circuitry, in an exemplary implementation of the invention;

FIG. 4 illustrates the base station system of FIG. 3 including an external fan assembly, in an exemplary implementation of the invention;

FIG. 5 illustrates an external view of a base station system, in an exemplary implementation of the invention;

FIG. 6A illustrates a base station system, in an exemplary implementation of the invention; and

FIG. 6B illustrates an exemplary cover for the base station system of FIG. 6A, in an exemplary implementation of the invention.

### DETAILED DESCRIPTION OF THE INVENTION

The embodiments discussed herein are illustrative of one example of the present invention. As these embodiments of the present invention are described with reference to illustrations, various modifications or adaptations of the methods and/or specific structures described may become apparent to those skilled in the art. All such modifications, adaptations, or variations that rely upon the teachings of the present invention, and through which these teachings have advanced the art, are considered to be within the scope of the present invention. Hence, these descriptions and drawings should not be considered in a limiting sense, as it is understood that the present invention is in no way limited to only the embodiments illustrated.

A base station system comprises a first structure, an enclosure, and a chimney. The first structure supports base station circuitry that generates heat. The enclosure encloses the first structure and the base station circuitry to form an internal space. The chimney comprises a second structure forming dedicated space for heat dissipation. The chimney transfers the heat from the internal space to an external space outside the enclosure.

One advantage is that the chimney prevents poor performance induced by the heat of the base station circuitry. The chimney also prevents the heat from potentially damaging the base station circuitry. The chimney may reduce the size, weight, and complexity of the base station system while providing adequate cooling for the base station circuitry. For example, base station circuitry providing voice and data services as previously discussed, such as GSM and SMS, may be compactly installed in a smaller form factor (e.g. micro or pico) base station system with the chimney cooling the base station circuitry.

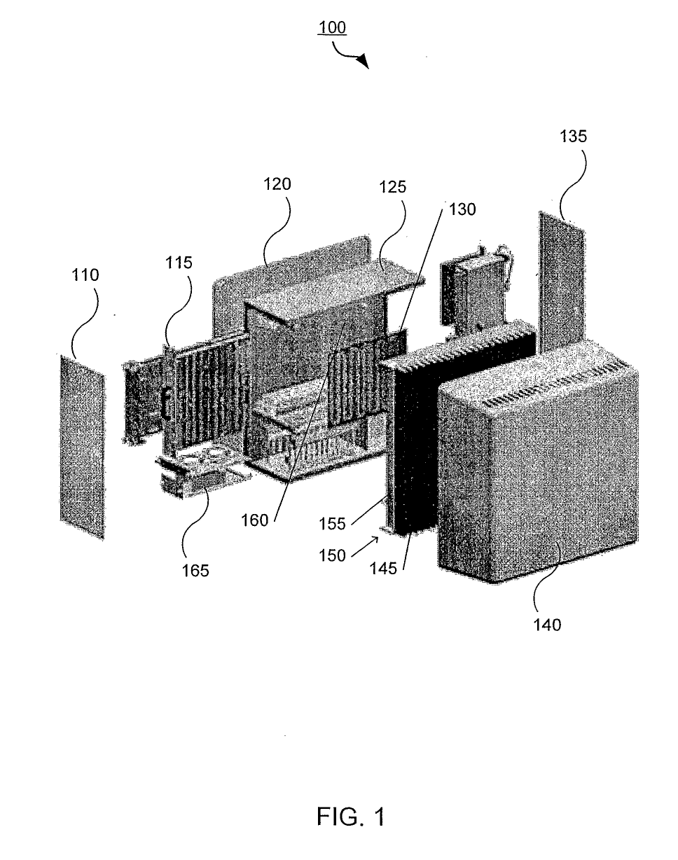

FIG. 1 illustrates a base station system including a chimney providing dedicated space for heat dissipation, in an exemplary implementation of the invention. The base station system 100 includes a first access panel 110, a radio transceiver 115, a wall mount 120, a housing 125, a heat foil 130, a second access panel 135, a cover 140, a heat sink 145, a chimney 150, a heat sink chassis 155, a backplane 160, and a fan assembly 165.

The base station system 100 includes the first access panel 110, the second access panel 135, and the housing 125 coupled to the heat sink 145 and the heat sink chassis 155 to form an enclosure around the base station circuitry, such as the radio transceiver 115. The enclosure is any structure that encloses base station circuitry and forms an internal space. In this embodiment, the first access panel 110, the second access panel 135, the housing 145, and the heat sink chassis 155 enclose the base station circuitry in an internal space. The first access panel 110, the second access panel 135, the housing 145, and the heat sink chassis 155 may be made from sheet metal or materials typically used to construct base stations (e.g. metal or plastic). Additionally, the wall mount 120 optionally mounts to the enclosure to secure the base station system 100 to a location for operation.

Mounting the base station system 100 to a pole, a tower, or a building exposes it to weather conditions that may adversely affect its operation. In some embodiments, to keep dust and other particles (e.g. plant matter) from adversely affecting the base station circuitry the enclosure prevents air outside the enclosure from mixing with air inside the enclosure. The enclosure may prevent rain, snow, wind, and other elements from penetrating the enclosure and causing damage to the internal base station circuitry.

The base station circuitry is supported in the enclosure by the first structure. The first structure is any structure that supports or assists in supporting the base station circuitry. In FIG. 1, the backplane 160 forms the first structure and is mounted inside the enclosure (e.g. to the housing 125) to support the base station circuitry. In this example, the backplane 160 supports the radio transceiver 115 and the heat foil 130. In some embodiments, the backplane 160 includes a copper layer providing electrical ground and aiding heat transfer from the base station circuitry to the internal space.

The base station circuitry is any circuitry in a telecommunication base station that provides or assists in providing telecommunication services. The base station circuitry may include components in addition to the radio transceiver 115 and the heat foil 130. Some examples of base station circuitry include processors, memory, communication interfaces, and power supplies. A person of ordinary skill in the art will understand that the base station circuitry may comprise any combination of electronic circuitry that is located in the base station and that provides or assists in providing telecommunication services, not just those listed as examples herein.

In some embodiments, the base station circuitry includes a thermal control board (not shown) mounted to the backplane 160 within the enclosure. The thermal control board monitors the temperature of the internal space inside the enclosure to control the fan assembly 165. At predefined temperatures, the thermal control board may start or stop the fan assembly 165 or increase the rotational speed of the fan assembly 165 to facilitate heat dissipation. The thermal control board may also control the heat foil 130 based on the temperature of the internal space. The heat foil 130 heats the base station circuitry to an operational temperature so that the base station system may operate in cold temperatures.

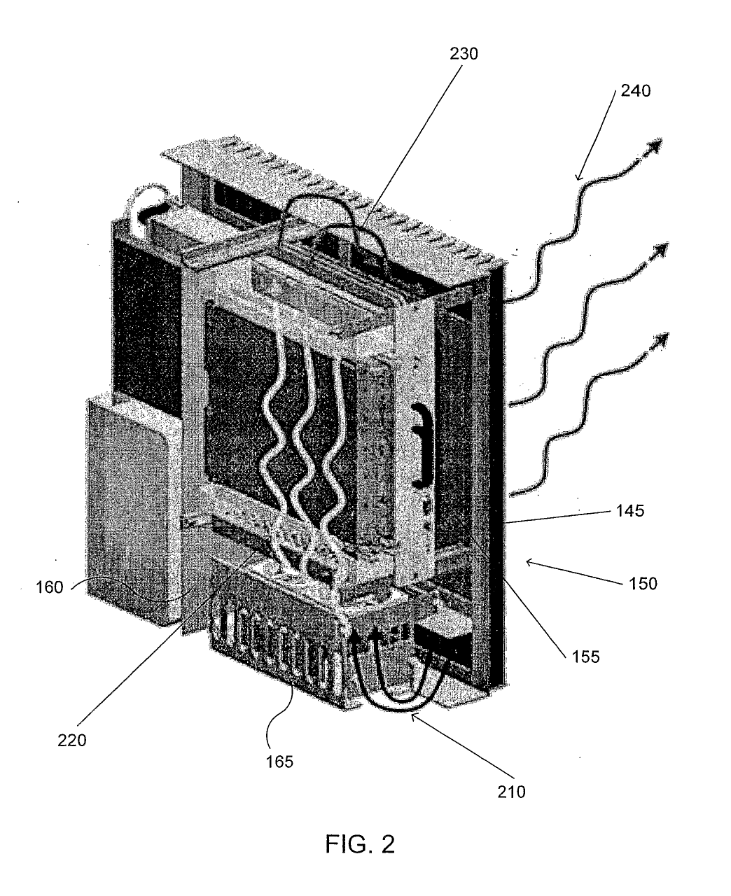

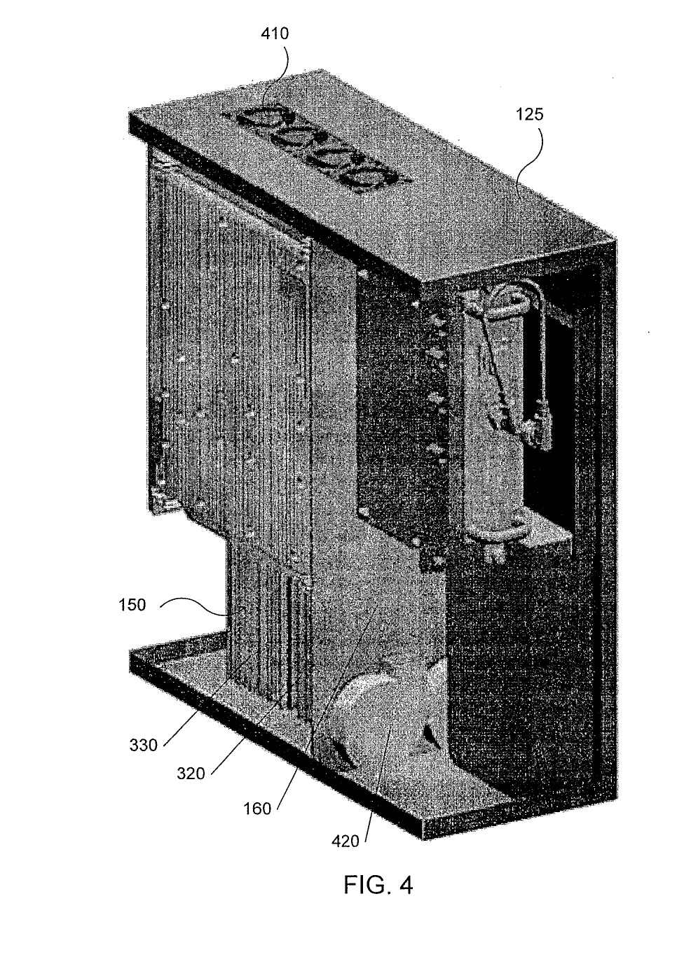

The fan assembly 165 comprises any device that creates a continuous flow of air. In one example, the fan assembly 165 is mounted inside the enclosure and forces air in the internal space over the base station circuitry. As depicted in FIG. 2 and discussed below, the fan assembly 165 forces the air into the chimney 150 where the chimney 150 dissipates the heat to the external space. The fan assembly 156 then draws cooler air out from the chimney 150 and forces the cooler air again over the base station circuitry. In another example, the fan assembly 165 mounts to the chimney 150 and forces air from the chimney 150 to the external space outside the enclosure discussed below as depicted in FIG. 4 and discussed below.

The chimney 150 is any structure in a base station system that forms dedicated space for heat dissipation. Referring to FIG. 1, the chimney 150 is formed by coupling the heat sink 145 to the heat sink chassis 155. The space formed between the heat sink 145 and the heat sink chassis 155 is dedicated to heat dissipation. The chimney 150 allows the air heated by the base station circuitry to flow across the heat sink 145. The heat sink 145 then cools the air. In this example, the heat sink chassis 155 is exposed in the internal space to air heated by the base station circuitry. The air enters the chimney 150 near the top of the heat sink chassis 155. The air comes into contract with the heat sink 145 as the air flows downward in the space between the heat sink 145 and the heat sink chassis 155. The air then exits the chimney 150 near the bottom of the heat sink chassis 155. This process is depicted in FIG. 2 and discussed in further detail below.

The shape of the chimney 150 may be, for example, a cylinder, a 3-dimensional (3-D) rectangle, a pyramid, or a cone. In FIG. 1, the heat sink 145 and the heat sink chassis 155 form the substantially 3-D rectangular chimney 150 being elongated along the height of the base station system 100. The shape of the chimney 150 may also have curves. For example, the heat sink 155 may have a curved convex or concave surface either internally to the enclosure of exposed to the external space. In one example, the chimney 150 forms pipes or flues. In another example, the chimney 150 forms a cone that has a narrow end exposed to the external space through which the heat may dissipate.

The chimney 150 may have a variety of orientations, such as horizontal or vertical. A vertically oriented chimney 150 has at least one end exposed to the external space at or near the top of the base station system 100. The vertically oriented chimney 150 may facilitate natural convection because less dense air at a higher temperature typically rises vertically. The rising air follows the vertical structure of the chimney to the external space. However, the vertically oriented chimney 150 may accumulate dirt, water or other particles inside the chimney and maybe inside the enclosure potentially affecting the operation of the base station circuitry. This problem may be solved by covering or shielding the end exposed to the external space. For example, covering the enclosure and the chimney 150 with the cover 140 prevents dust and rain from entering the chimney 150 and the enclosure.

A horizontally oriented chimney 150 has at least one end exposed to the external space at or near one side of the base station system 100. The horizontally oriented chimney 150 may slow the processes of natural convection because the less dense air has to travel the horizontal length of the chimney to escape to the external space. The unprotected horizontally oriented chimney 150 may not accumulate water, but still may suffer from the accumulation of dirt or other particles. It will become apparent to those skilled in the art the numerous variations in the shape, size, and spatial configuration of the chimney 150 that are within the scope of the present invention. The examples and embodiments illustrated in this disclosure are not to be viewed or understood as limiting in any way with respect to the shape, size, and spatial configuration of the chimney 150.

The chimney 150 may utilize a forced internal airflow to transfer the heat generated by the base station circuitry into the chimney 150 for dissipation. In these embodiments, air (e.g. forced by the fan assembly 165) flows over the base station circuitry and through an opening in the chimney 150. The chimney 150 then removes the heat from the air, for example, by passing the heated air over the cooler heat sink 145. The chimney 150 may also expel the heated air to the external space (e.g. by using the fan assembly 165).

In some embodiments, the base station circuitry mounts directly to the chimney 150 in the base station system 100. The heat generated by the base station circuitry transfers directly to the chimney 150 though contact with the base station circuitry. This direct contact maximizes heat removal by directing the heat away from the base station circuitry. The chimney 150 may more readily dissipate the heat generated by base station circuitry from the air within the internal space.

The chimney 150 dissipates heat to the external space using a variety of methods. In some embodiments, the chimney 150 employs natural convection to dissipate the heat. In these embodiments, heat from the internal space dissipates to ambient air outside the enclosure. The now heated ambient air circulates away from the base station system 100 and cooler ambient air having a higher density replaces the now heated ambient air. The circulation of the cooler ambient air and the heated ambient air naturally removes heat from the chimney 150 and cools the base station system 100. The chimney 150 may include heat sinks, (e.g. heat sink 145) to provide a larger surface area for convection to occur so that the chimney 150 may dissipate more heat.

The chimney 150 thus advantageously lowers the temperature of the base station system 100 (e.g. by dissipating the heat generated by the base station circuitry). Additionally, the chimney 150 provides dedicated space in which to direct or focus heat dissipation. The chimney 150 directs heat away from the base station circuitry to prevent poor performance and heat damage.

The base station system 100 may be a macro, micro, or pico telecommunication base station. The macro base station system typically has a higher output power and supports more communication channels with mobile devices than the micro or pico base station. The macro base station may use an antenna located above the average roof top height to service a large geographic area with rapidly moving traffic. The micro base station typically is smaller, has fewer communication channels than the macro base station, and may be used to relieve capacity in hot spots (e.g. areas of high wireless traffic) covered by macro base stations. The micro base stations typically use an antenna located significantly below the height of surrounding buildings. The pico base station is even smaller than the micro base station and may be used to provide better indoor coverage where wireless traffic is generally stationary.

FIG. 2 illustrates an internal view of a base station system dissipating heat by forcing air into a chimney, in an exemplary implementation of the invention. In this embodiment, the fan assembly 165 dissipates the heat generated by the base station circuitry by forcing air in the internal space into the chimney 150. For example, the fan assembly 165 forces cooler air depicted by arrows 210 over the base station circuitry. The cooler air 210 picks up the heat generated by the base station circuitry and becomes heated air depicted by arrows 220. The fan assembly 165 continues to force the now heated air 220 into the chimney 150 through the heat sink chassis 155 as depicted by arrows 230. The heated air 230 enters the chimney 150 near the top of the heat sink chassis 155. The heated air 230 flows downward toward the bottom of the heat sink chassis 155 through the dedicated space formed between the heat sink 145 and the heat sink chassis 155.

The cooler heat sink 145 removes the heat from the heated air 230. The heat sink 145 dissipates the heat to the external space outside the enclosure. In this example, natural convection transfers the heat in the heat sink 145 to external air in the space outside the enclosure as depicted by arrows 240. The now cooler air 210 exits the chimney 150 near the bottom of the heat sink chassis 155. The fan assembly 165 draws the cooler air 210 from the chimney and forces the cooler air 210 again into the internal space. In this manner, the fan assembly 165 circulates cooler air and forces heated air in the internal space into the chimney 150 for heat dissipation.

In some embodiments, the heated air 230 exits out of the chimney 150 to the external space. For example, the chimney 150 may provide a vent (not shown) in the heat sink 145 or the heat sink chassis 155 leading out to the external space. The vent allows the heated air 230 to flow out of the chimney 150. Similarly, the chimney 150 may provide an intake vent (not shown) in the heat sink 145 or heat sink chassis 155. The fan assembly 165 may draw the cooler air 210 through the intake vent for circulation in the internal space.

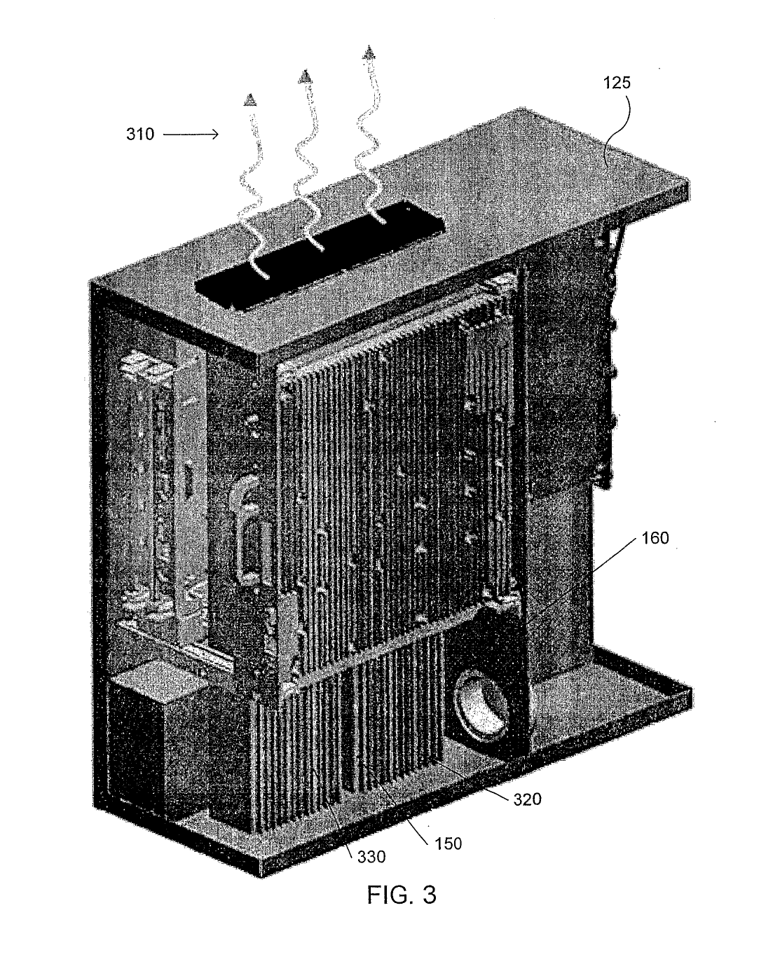

FIG. 3 illustrates a base station system including a chimney mounted to base station circuitry, in an exemplary implementation of the invention. In this example, a heat sink 320 and a heat sink 330 form the chimney 150. The heat sinks 320 and 330 are formed from any heat conductive material, such as metal. The heat sink 320 and 330 each form a rectangular box and each have at least one end exposed to the external space outside the enclosure (i.e., through the enclosure 125).

To dissipate heat, the heat sinks 320 and 330 may form hollow internal structures, such as passageways or conduits, which permit air outside the enclosure to enter the heat sinks 320 and 330. The heat sinks 320 and 330 are vertical to the base station system 100 and allow heat to dissipate to cooler ambient air inside the internal conduits of each heat sink 320 and 330. The cooler ambient air, when heated, rises through the conduits to the top of each heat sink 320 and 330. The heat sinks 320 and 330 may include fins exposed to the internal space or the external space to provide additional surface area for heat transfer.

In this example, the chimney 150 directs heat away from the base station circuitry in the internal space in two ways. First, the chimney 150 is directly coupled to the base station circuitry that generates heat. In other words, the chimney 150 is in direct contact with the base station circuitry or coupled to a heat sink or heat transfer surface that is mounted to the base station circuitry. This maximizes the heat transfer away from the base station circuitry to the chimney 150. Second, the chimney 150 removes heat from the air in the internal space using the internal fins of heat sink 320 and 330. The heat in the air in the internal space dissipates to the cooler surface of the fins of each heat sink 320 and 330. The chimney 150 then transfers the heat to cooler external air inside the conduits. In the conduits, less dense heated air rises away from the base station system 100 as depicted by arrows 310. Cooler air having a higher density enters the conduits to replace the rising heated air 310. This cools the base station system 100 and the base station circuitry. The chimney 150 directs heat away from the base station circuitry to the external space outside the enclosure to protect the base station system 100 from heat damage.

FIG. 4 illustrates the base station system of FIG. 3 including an external fan assembly, in an exemplary implementation of the invention. The external fan assembly 410 facilitates heat dissipation by the chimney 150 by forcing air out of the conduits in the chimney 150. In some embodiments, the chimney 150 may have at least two ends exposed to the external space so that air may flow from the one end of the chimney 150 through the conduits to the second end. The external fan assembly 410 accelerates the passage of air through the conduits by forcing the air through the conduits of the heat sinks 320 and 330. This provides heat dissipation by quickly removing heated air and allowing cooler air to fill the conduits.

In some embodiments, the base station system 100 includes an internal blower assembly 420 as shown in FIG. 4. The internal blower assembly 420 is any device (e.g., a fan or a blower) that forces air. The internal blower assembly 420 may be mounted to the enclosure or to the base station circuitry to facilitate heat dissipation. In this example, the internal blower assembly is coupled to the backplane 160. The internal blower assembly 420 forces air over the backplane 160 and the base station circuitry and into the internal space. The chimney 150 then may dissipate the heat from the air in the internal space to the external space outside the enclosure.

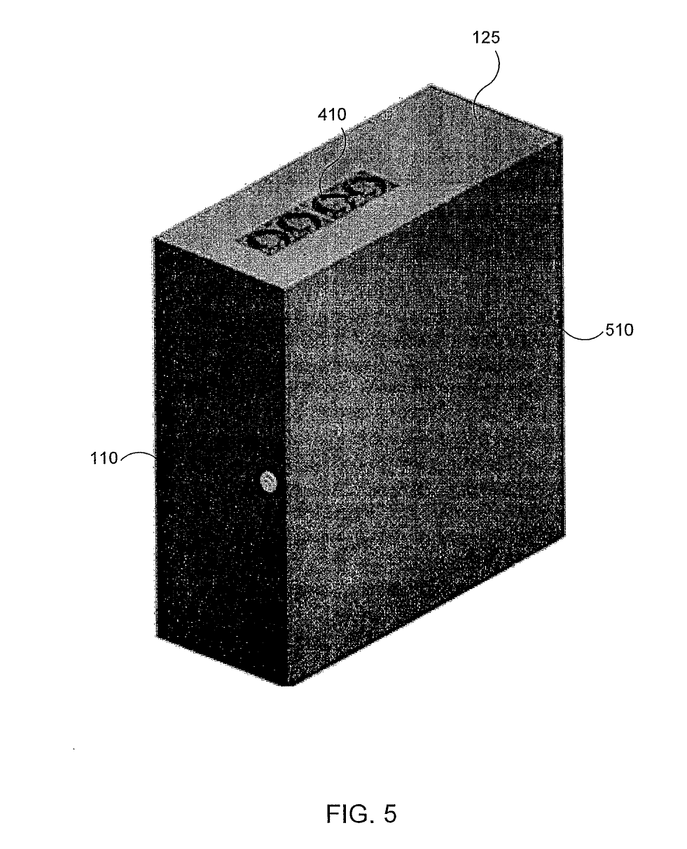

FIG. 5 illustrates an external view of a base station system, in an exemplary implementation of the invention. In this embodiment, the first access panel 110, the second access panel 135 (not shown), the housing 125, and a housing wall 510 form the enclosure for the base station system 100. The chimney 150 (not shown) is mounted inside the enclosure. The chimney 150 includes the external fan assembly 410 and cools the base station system 100. The chimney 150 may include at least two end exposed to the external space outside the enclosure.

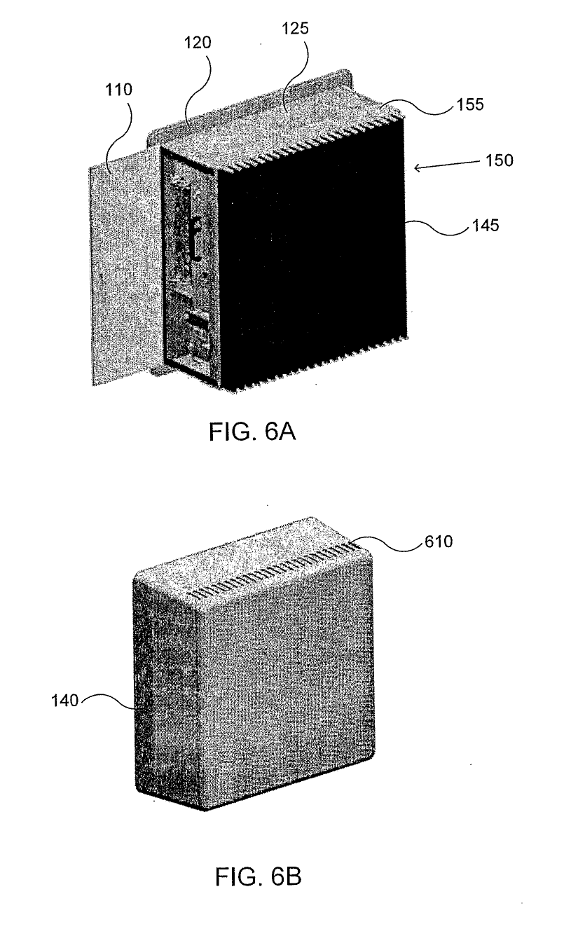

FIG. 6A illustrates a base station system, in an exemplary implementation of the invention. FIG. 6B illustrates an exemplary cover for the base station system of FIG. 6A, in an exemplary implementation of the invention. The cover 140 protects the base station system 100 from rain and solar radiation. In this example, the cover 140 includes ventilation holes 610 to aid in air circulation.

The above description is illustrative and not restrictive. Many variations of the invention will become apparent to those of skill in the art upon review of this disclosure. The scope of the invention should, therefore, be determined not with reference to the above description, but instead should be determined with reference to the appended claims along with their full scope of equivalents.

What is claimed is:

1. A base station system comprising:
a first structure configured to support base station circuitry that generates heat;
an enclosure configured to enclose the first structure and the base station circuitry and form an internal space; and
a chimney configured to transfer the heat from the internal space to an external space outside the enclosure, the chimney comprising a second structure forming dedicated space for heat dissipation.

2. The base station system of claim 1, wherein the base station system comprises a micro base station.

3. The base station system of claim 1, wherein the base station system comprises a Global System for Mobile Communication base station.

4. The base station system of claim 1, wherein the base station system comprises a macro base station.

5. The base station system of claim 1, wherein the chimney is substantially vertical.

6. The base station system of claim 1, wherein the chimney forms a rectangular box.

7. The base station system of claim 1, wherein the chimney is enclosed in the internal space.

8. The base station system of claim 1, wherein the chimney is configured to dissipate the heat from the internal space to the external space using natural convection.

9. The base station system of claim 1, further comprising a fan configured to dissipate the heat.

10. The base station system of claim 9, wherein the fan is configured to dissipate the heat from the internal space using an internal airflow configured to flow over the base station circuitry and into the chimney.

11. The base station system of claim 9, wherein the fan is configured to dissipate the heat from the second structure to the external space outside the enclosure using a chimney airflow to the external space.

12. The base station system of claim 1, further comprising a heat sink configured to dissipate the heat.

13. The base station system of claim 12, wherein the heat sink is coupled to the base station circuitry and is configured to dissipate the heat from the base station circuitry to the internal space.

14. The base station system of claim 12, wherein the heat sink is coupled to the chimney and is configured to dissipate the heat from the second structure to the external space.

15. The base station system of claim 1, further comprising the base station circuitry.

16. The base station system of claim 15, wherein the base station circuitry is coupled to the chimney and is configured to transfer the heat to the chimney.

17. The base station system of claim 1, wherein the first structure comprises a back plane coupled to the base station circuitry.

18. The base station system of claim 1, further comprising an enclosure cover structure configured to cover the base station system from solar radiation and water.

19. The base station system of claim 1, further comprising a thermal control board configured to monitor an internal temperature of the internal space and operate a blower based on the internal temperature.

20. The base station system of claim 1, further comprising a heat foil configured to heat the base station circuitry to an operational temperature using an electric current through the heat foil.

21. A method for base station heat dissipation comprising:
supporting base station circuitry that generates heat using a first structure;
enclosing the first structure and the base station circuitry using an enclosure forming an internal space; and
transferring the heat from the internal space to an external space outside the enclosure using a chimney comprising a second structure forming dedicated space for heat dissipation.

22. The method of claim 21, further comprising dissipating the heat from the internal space to the external space using natural convection by the chimney.

23. The method of claim 21, further comprising dissipating the heat using a fan configured to force an internal airflow over the base station circuitry to the chimney.

24. The method of claim 21, further comprising dissipating the heat using a fan configured to force a chimney airflow from the second structure to the external space outside the enclosure.

25. The method of claim 21, further comprising dissipating the heat from the base station circuitry to the internal space using a heat sink coupled to the base station circuitry.

26. The method of claim 21, further comprising dissipating the heat from the chimney to the external space outside the enclosure using a heat sink coupled to the chimney.

27. The method of claim 21, further comprising mounting the base station circuitry to the chimney and configuring the base station circuitry to transfer the heat to the chimney.

28. The method of claim 21, further comprising monitoring an internal temperature of the internal space using a thermal control board and operating a blower based on the internal temperature.

29. A base station system comprising:
a supporting means for supporting base station circuitry that generates heat;
an enclosing means for enclosing the supporting means and the base station circuitry and forming an internal space; and
a heat transfer means for transferring the heat from the internal space to an external space including a dissipation means for forming dedicated space for heat dissipation.
